(19) United States
(12) Patent Application Publication
(10) Pub. No.: US 2019/0168933 A1
(43) Pub. Date: Jun. 6, 2019

(54) SELF-SUPPORTING OR MOUNTABLE SCOOP OR MEASURING SPOON

(71) Applicant: Lesley Jackson, Newark, DE (US)

(72) Inventor: Lesley Jackson, Newark, DE (US)

(21) Appl. No.: 15/833,801

(22) Filed: Dec. 6, 2017

(51) Int. Cl. B65D 51/24; A47J 45/02; G01F 19/00

(52) U.S. Cl. CPC B65D 51/246; G01F 19/002; A47J 45/02

(57) ABSTRACT

An improved scoop combination or measuring spoon combination (FIG. 1A) (1) having a handle (2) with a bowl (3) at one end and, at the opposing end, a bracket that removably mounts to a container closure (FIG. 1B) (10). The top of the bracket is covered and substantially angled to support the scoop or measuring spoon combination (1) on a work surface and to catch remnants of material that may fall from the scoop or measuring spoon combination (1) while in the self-supporting position (FIG. 2). Additionally, the bowl (3) of the scoop or measuring spoon may have measurement marks (8), and the top of the bracket may remain open to provide a way for a human to easily cause the scoop or measuring spoon combination (1) to scoop out or measure the ingredients of a container. Thus, several advantages include keeping scoops or measuring spoons from getting lost, getting crusty with granular material that came into contact with a wet surface, and taking up more counter or drawer space.

### CROSS-REFERENCE TO RELATED APPLICATION

This application claims the benefit of provisional patent application No. 62/430,428, filed Dec. 6, 2016 by the present inventor. The substitute specification contains no new matter.

### BACKGROUND

This relates to scoops or measuring spoons, especially measuring spoons for herb and spice jars and scoops to use with bottles of craft material, like glitter and micro beads. Scoops and measuring spoons can get scarce and, when they do, they can increase the frustration of those who need to use the scoop or measuring spoon to scoop or measure materials to make a concoction. Keeping a scoop or measuring spoon available is largely a result of having many of them. U.S. Pat. No. 3,001,404 to McDonnell, Jr., et al (1961), U.S. Pat. No. 8,650,951 B2 to Kern et al (2014) and U.S. Pat. No. 8,806,935 B2 to Hood et al (2014) are all conventional scoops or measuring spoons that one can buy by the dozen if they so desire. However, having so many measuring spoons adds to the amount of cleanup after preparing a concoction for consumption or for crafting.

Scoops and measuring spoons can carry remnants of material from one container to the next container and, when they do, they can cause their users to make the contents of one or both containers adulterated and messy. Keeping material free from contamination is largely a result of keeping the scooping means free of the material of another container. One way to accomplish this is to have a designated spoon for each container. U.S. Pat. No. 1,768,771 to Tourrette (1929) has a scoop or measuring spoon within a container that reserves space for the scoop or measuring spoon. However, this solution takes away from space that could be used to hold more granular material. U.S. Pat. No. 5,482,095 to de Chollet (1996) has a container that reserves a spoon holder on the outside of the container for a scoop or measuring spoon for using specifically to retrieve the contents of that container, in that case medicine. However, any remnants of contents contained on the scoop or measuring spoon will spill into the spoon holder if not washed before putting away.

Scoops or measuring spoons, even designated scoops measuring spoons, can get crusty and, when they do, they can cause waste and thus deny their users the use of all of the material within the container. Keeping a scoop or measuring spoon from getting crusty is largely a result of preventing it from resting on or coming into contact with wet surfaces, especially while any granular material remains on the scoop or measuring spoon. U.S. Pat. No. 2,165,045 to Garside (1939) is merely a self-supporting spoon, and U.S. Pat. No. 8,215,167 B2 to Hall (2012) is a self-supporting measuring scoop that is designated to a container and must still be kept away from wet surfaces in order to avoid clumping any of the granular material left on the scoop. Terapeak, of Canada, has sold at least two versions of the Vintage Midcentury Lustroware Measuring Spoons In Wall Mounted Ceramic Tree, and Foter, of Poland, has sold Tin Woodsman 5-Piece Paula Deen Exclusive Measuring Spoon Set. However, Terapeak's and Foter's solutions merely keep the scoops or measuring spoons off of a surface and can still take up valuable work surface space.

In conclusion, as far as I am aware, no scoop or measuring spoon formerly developed is designated to a particular container to remain visible, accessible, and free from granular crust without significantly reducing work surface or drawer space.

### SUMMARY

An improved scoop or measuring spoon has a handle with a bowl at one end and, at the opposing end, a bracket that removably mounts to a container closure. The top of the bracket is substantially angled and covered so as to support the scoop or measuring spoon on a work surface and to catch remnants of material that may fall from the scoop or measuring spoon while in the self-supporting position. Additionally, the bowl may have measurement marks, and the top of the bracket may be left open so as to provide a means for a human to more easily cause the scoop or measuring spoon to scoop out or measure the ingredients of a container. This allows the user to have available at all times a dedicated scoop or measuring spoon per certain container.

Accordingly, several advantages are to reduce instances of missing scoops or measuring spoons, to reduce instances of crusty scoops or measuring spoons hardened with granular material that came into contact with a wet surface, and to avoid taking up more counter or drawer space. Still further advantages will become apparent from a study of the following description and the accompanying drawings.

### DRAWINGS

FIG. 1A is a perspective view of a first embodiment of a scoop or measuring spoon combination.

FIG. 1B is a perspective view of a scoop or measuring spoon combination mounted on a container closure.

FIG. 2 is a perspective view of a scoop or measuring spoon combination in a self-supporting position.

FIG. 3 is a perspective view of a second embodiment of a scoop or measuring spoon combination.

### REFERENCE NUMERALS

1 scoop or measuring spoon combination

2 handle

3 bowl

4 side member

5 bottom of side member

6 top of side member

7 top member

8 measurement marks

9 container

10 container closure

11 the underside of the side member

### Detailed Description of Scoop or Measuring Spoon with Surface Guard

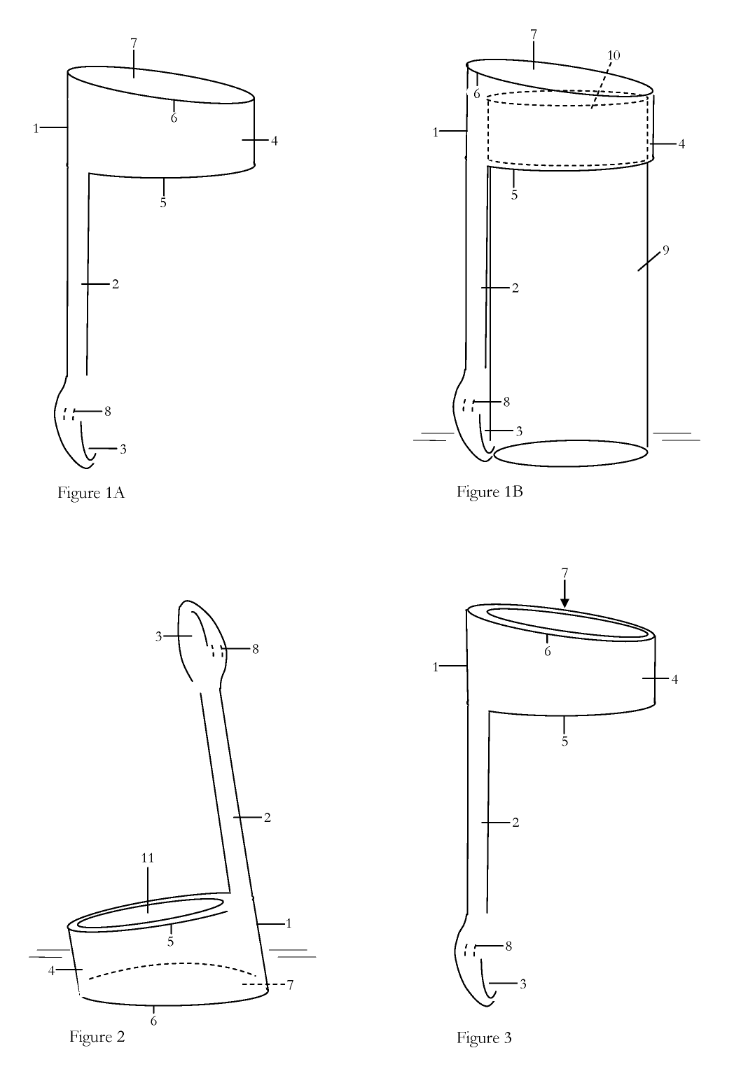

FIG. 1A is a perspective view of a first embodiment of a scoop or measuring spoon combination 1 that includes a handle 2, a bowl 3 that is a predetermined size and may support measurement marks 8, a side member 4, and a top member 7. The bottom of the handle 2 supports the bowl 3 and the top of the handle 2 supports the side member 4 that is substantially curved. A bottom of side member 5 extends straight out and a top of side member 6 extends downwardly. The side member 4 supports the top member 7 that is manufactured to fit the shape of a respective container closure. The bowl 3 is facing the same direction as the side member 4 extension.

FIG. 1B is a perspective view of a first embodiment of a scoop or measuring spoon combination 1 mounted on a container closure 10, where a container 9 supports the container closure 10 that supports the scoop or measuring spoon combination 1, and the scoop or measuring spoon combination 1 fits closely around the container closure 10.

FIG. 2 is a perspective view of a scoop or measuring spoon combination 1 in a self-supporting position, where the underside of the side member 11 faces up and the top member 7 rests on a flat work surface.

### Detailed Description of Scoop or Measuring Spoon with Thumb Support

FIG. 3 is a perspective view of a second embodiment of a scoop or measuring spoon combination, eliminating where the top member 7 is left open.

### Operation of Scoop or Measuring Spoon with Surface Guard

In operation, a human uses a scoop or measuring spoon combination 1 to scoop contents from a container 9. First, the human removes the scoop or measuring spoon combination 1. Second, the human removes a container closure 10 from the container 9. Third, the human holds either a side member 4 or a handle 2 or both and inserts a bowl 3 of the scoop or measuring spoon combination 1 into the container 9 as a means of retrieving the contents, perhaps using the measurement marks 8 within the bowl 3 as a means for specific measurement, and then to use the contents. The human may set the scoop or measuring combination 1 on a work surface that supports the top member 7 and keeps the bowl 3 away from anything wet that may exist on the work surface. Any remnants of the contents around the bowl 3 and handle 2 fall through the bottom of the side member 5 and onto the underside of the side member 11 due to a substantial angle of the top of the side member 6. When finished, the human places the measuring scoop or spoon member 1 onto the container closure 10 to rest until the next use.

### Operation of Scoop or Measuring Spoon with Thumb Support

In a second embodiment, a human uses a scoop or measuring spoon combination 1 to scoop contents from a container 9. First, the human removes the scoop or measuring spoon combination 1. Second, the human removes a container closure 10 from the container 9. Third, the human may insert his or her finger or thumb through openings a top of side member 6 and a bottom of side member 5 as a means of retrieving the contents, perhaps using the measurement marks 8 within the bowl 3 as a means for specific measurement, and then to use the contents. The human may set the scoop or measuring combination 1 on a work surface that supports the top member 7 and keeps the bowl 3 away from anything wet that may exist on the work surface. When finished, the human places the scoop or measuring scoop combination 1 onto the container closure 10 to rest until the next use.

### CONCLUSION, RAMIFICATIONS, AND SCOPE

Accordingly, the reader will notice the angle of a closed top member is such that can rest on a surface and aid in catching granular material as it falls from the spoon; an open top member allows ease of use by permitting a human finger through it; and the top member, whether open or closed, can additionally be used to keep the spoon away from wet surfaces.

Although the description above contains many specificities, these should not be construed as limiting the scope of the embodiments but as merely providing illustrations of some of several embodiments. For example, the side member can contain threading inside so as to be used in place of the regular jar top.

Thus the scope and embodiments should be determined by the appended claims and their legal equivalents, rather than by the examples given

I claim:

1. A method for manufacturing a scoop or measuring spoon, comprising providing said scoop or measuring spoon with a bracket that may removably attach to a closure of a container, whereby a human uses said method to reduce instances of lost scoops or measuring spoons, crusty scoops or measuring spoons from coming into contact with a wet surface, and contaminated containers from using the same scoop or measuring spoon between containers.

2. The method of claim 1, wherein said container is substantially purposed for holding granular material.

3. The method of claim 1, wherein said bracket extends from the part of said scoop or measuring spoon that opposes the bowl of said scoop or measuring spoon.

4. The method of claim 1, wherein said container is substantially purposed for holding granular material and said bracket extends from the part of said scoop or measuring spoon that opposes the bowl of said scoop or measuring spoon.

5. A scoop or measuring spoon combination, comprising:
a) a scoop or measuring spoon;
b) a primary means for removably attaching said scoop or measuring spoon to a container closure, said means also being able to support said scoop or measuring spoon on a work surface;
whereby a human uses said combination to reduce instances of lost scoops or measuring spoons, crusty scoops or measuring spoons from coming into contact with a wet surface, and contaminated containers from using the same scoop or measuring spoon between containers.

6. The scoop or measuring spoon combination of claim 5, wherein said means is a bracket that substantially fits over said container closure.

7. The scoop or measuring spoon combination of claim 5, wherein said container closure generally encloses a container substantially purposed for holding granular material.

8. The scoop or measuring spoon combination of claim 5, wherein said means is a bracket that substantially fits over said container closure that generally encloses a container substantially purposed for holding granular material

9. A self-supporting or mountable scoop or measuring spoon, comprising:
a) a scoop or measuring spoon having a bowl and a handle;
b) a bracket that extends from one end of said handle that supports the bowl on the opposing end;
c) said scoop or measuring spoon affixed to said bracket that may removably mount to a container closure;
whereby a human uses said scoop or measuring spoon to reduce instances of lost scoops or measuring spoons, crusty scoops or measuring spoons from coming into contact with a wet surface, and contaminated containers from using the same scoop or measuring spoon between containers.

10. The self-supporting or mountable scoop or measuring spoon of claim 9, wherein said container is substantially purposed for holding granular material.

11. The self-supporting or mountable scoop or measuring spoon of claim 9, wherein said bracket fits over said container closure and is substantially angled as a means for said bracket to support said scoop or measuring spoon on a work surface.

12. The self-supporting or mountable scoop or measuring spoon of claim 9, wherein the top said bracket is closed so as to cover said container closure.

13. The self-supporting or mountable scoop or measuring spoon of claim 9, wherein said container is substantially purposed for holding granular material, and said bracket fits over said container closure and is substantially angled as a means for said bracket to support said scoop or measuring spoon on a work surface.

14. The self-supporting or mountable scoop or measuring spoon of claim 9, wherein said container is substantially purposed for holding granular material, and the top said bracket is closed so as to cover said container closure.

15. The self-supporting or mountable scoop or measuring spoon of claim 9, wherein said bracket fits over said container closure and is substantially angled as a means for said bracket to support said scoop or measuring spoon on a work surface, and the top said bracket is closed so as to cover said container closure.

16. The self-supporting or mountable scoop or measuring spoon of claim 9, wherein said container is substantially purposed for holding granular material, said bracket fits over said container closure and is substantially angled as a means for said bracket to support said scoop or measuring spoon on a work surface, and the top said bracket is closed so as to cover said container closure.
